(19) United States
(12) Patent Application Publication
(10) Pub. No.: US 2012/0044047 A1
(43) Pub. Date: Feb. 23, 2012

(54) ELECTRONIC ACCESS CONTROL OF HAZARDOUS ZONES

(76) Inventor: William Morgan, San Luis Obispo, CA (US)

(21) Appl. No.: 13/318,375

(22) PCT Filed: Feb. 4, 2010
(86) PCT No.: PCT/US10/23143

§ 371 Date: Nov. 1, 2011

Related U.S. Application Data
(60) Provisional application No. 61/219,895, filed on Jun. 24, 2009.

(51) Int. Cl. G06F 7/04

(52) U.S. Cl. 340/5.2

(57) ABSTRACT

A zone access control system is described. The system is particularly suited for controlling access to radioactive or potentially radioactive areas. The system comprises one or more portable devices that are worn or otherwise carried by individuals in the facility or region of interest. The system also comprises one or more intelligent barriers that govern or restrict entry into or exit from, one or more zones of interest. And, the system comprises a computer or computer system to process information and provides control instructions to the barriers and to the portable devices. Various methods of operation are also described.

### CROSS REFERENCE TO RELATED APPLICATIONS

This application is a national stage application of International Application No. PCT/US2010/023143 filed Feb. 4, 2010, which claims priority upon U.S. provisional application Ser. No. 61/219,895 filed. Jun. 24, 2009, which is hereby incorporated by reference.

### FIELD OF INVENTION

The present invention relates to controlling and monitoring access into and out of buildings and designated areas. The invention is particularly directed to controlling entry and exit in nuclear facilities.

### BACKGROUND OF THE INVENTION

Regulatory bodies that oversee nuclear facilities in the United States require licensees to strictly control access to radiation areas. Regulations typically categorize radiation areas according to the level of risk. Physical and administrative measures must be employed to protect personnel from the dangers inherent in these areas. Physical measures frequently include the use of delineated boundaries (typically established by rope or fences), barriers (provided by doors or gates) and signage. Administrative measures include practices such as requiring certain training, documenting pre-job briefs and the use of radiation work permits. Entry requirements for each area differ according to the hazard level.

Entry into a radiation area typically requires a certain level of training, specific permission from facility management, formal briefings of conditions in the area, and a functioning personal monitoring device. Conditions within a hazardous zone must be known and stable before personnel may routinely enter. Equipment configuration must be such that the conditions do not adversely change while personnel are in the area.

A common problem encountered by nuclear facilities is unauthorized access to radiological areas by workers. Often workers who have been granted entry to one particular area will inadvertently enter areas of greater risk also present in the vicinity for which they have no authorization. Often it is the faulty judgment, understanding and discretion of the entrant that causes them to violate a radiation boundary or pass through an access point for which they are not allowed to enter. Unauthorized entry can also be intentional. Facilities are penalized by regulatory agencies for unauthorized entries into radiation areas resulting in fines, unintended worker exposure and in certain cases, unwanted media attention.

In view of these and other concerns, a need exists for a system and related method for controlling access to designated regions or areas of a controlled space, such as in a nuclear facility.

### SUMMARY OF THE INVENTION

The difficulties and drawbacks associated with previously known systems are overcome in the present method and apparatus for an electronic system for controlling access to radioactive or potentially radioactive areas. It will be appreciated that the invention is also applicable to controlling access to nonradioactive areas. For example, the methods and systems described herein can be employed for governing access to areas associated with sensitive equipment, valuable goods, or other areas having similar concerns.

In one aspect, the present invention provides a system for controlling access by individuals into one or more zone(s) of interest. The system comprises a plurality of portable devices each of which is carried by an individual and includes a microprocessor, memory provisions, an on-board power source, and provisions for transmitting information. The system also comprises at least one intelligent barrier associated with the zone of interest such that the intelligent barrier is selectively operable to allow entry by the individual into the zone of interest or deny entry into the zone of interest. The intelligent barrier includes provisions for transmitting information. And, the system comprises a computer system including (i) input provisions for receiving information from at least one of the plurality of portable devices and the at least one intelligent barrier, (ii) processing provisions for executing one or more algorithms using the received information, and (iii) output provisions for providing operating instructions to the at least one intelligent barrier according to the algorithms. The instructions from the computer system are used to selectively operate the at least one intelligent barrier to thereby allow or deny entry of the individual carrying a portable device into the zone of interest.

In another aspect, the present invention provides a method for controlling access into a zone of interest. The method comprises providing a system including (i) a portable device, (ii) an intelligent barrier associated with the zone of interest, and (iii) a computer system in communication with the portable device and the intelligent barrier. The method also comprises an operation of assigning the portable device to a user. The method also comprises an operation of transferring information associated with the user including user data to the portable device. The method may also comprise transferring information associated with the zone of interest including entry data to the portable device. The method further comprises the user presenting the portable device to the intelligent barrier upon attempting to access the zone of interest. The method then involves transferring the user data from the portable device to the computer system, and transferring the entry data from the portable device to the computer system. The computer system assesses whether the user data and the entry data is acceptable for access by the user, and if so, then issuing a signal to the intelligent barrier indicative of allowing access into the zone of interest. The intelligent barrier receives the signal and then enables access by a user into the zone of interest.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 is a schematic diagram illustrating a preferred system in accordance with the present invention.

FIG. 2 is a schematic diagram illustrating one form of communication between various components of the preferred system of the invention.

FIG. 3 is another schematic diagram illustrating another form of communication between various components of the preferred system of the invention.

FIG. 4 is another schematic diagram illustrating yet another form of communication between various components of the preferred system of the invention.

FIG. 5 is another schematic diagram illustrating yet another form of communication between various components of the preferred system of the invention.

FIG. 6 is a flowchart illustrating a preferred embodiment process for controlling access into a zone of interest in accordance with the invention.

FIG. 7 is a flowchart illustrating a preferred embodiment process for governing exit from a zone of interest in accordance with the invention.

FIG. 8 which includes FIGS. 8A and 8B, is a flowchart illustrating a preferred embodiment process for entering a zone using the preferred embodiment system.

FIG. 9 which includes FIGS. 9A and 9B, is a flowchart illustrating a preferred embodiment process for initiating and performing a system login sequence.

FIG. 10 is a flowchart illustrating a preferred embodiment process for performing a system logout sequence.

### DETAILED DESCRIPTION OF THE EMBODIMENTS

The present invention provides systems generally comprising three elements or types of components that interface to varying extents with one another to control safe access by personnel into one or more zones of interest. The components also operate to govern exiting by personnel from the zone(s) of interest. It will be understood that the methods and systems described herein can be implemented to screen entry into one or more area(s), exit from one or more area(s), and/or both entry into and exit from one or more area(s) of interest. The systems generally include information processing, management, and collection provisions. The elements of the systems include a user identifying portable device, an intelligent barrier, and a computer software and database system to administer access within the zone(s).

More specifically, the invention provides hazardous zone management systems that include a user identifying portable device (generally referred to herein as a “portable device”) that is capable of storing and transmitting data, a network of one or more intelligent barriers that control access, and a computer software and database system for control and management. The components communicate with one another in several preferred configurations as described in greater detail herein. The invention also provides methods for controlling and determining entry into and exit from controlled areas and in particular to one or more zone(s) of interest. The terms “controlled area” or “controlled space” refer to a physical region, the entry into or exit from which, can be governed by one or more intelligent barriers such as modified doors, turnstiles, access ports, passages, gates and the like. As described in greater detail herein, doors or doorways modified such that they can be locked, secured, or closed for example by receipt of an appropriate electronic control signal, may constitute an intelligent barrier. Similarly, turnstiles, access ports, passages, gates and the like, if selectively securable between a locked and an unlocked state, are also examples of suitable intelligent barriers. The term “zone of interest” refers to a controlled area or controlled space, or a portion thereof, or multiple controlled areas or spaces, the entry into or exit from which, is desired by personnel and which is governed by the noted barriers based upon certain data and other information gathered by or provided to the systems. Each of the three types of components of the preferred embodiment systems is described in greater detail as follows.

An example of a user identifying portable device is a programmable electronic dosimeter that is commonly used in the nuclear industry. As known by those skilled in the nuclear industry, a dosimeter is a device used to measure an individual's exposure to a hazardous environment, and typically measures exposure to ionizing radiation. The type of portable device preferred for use in the systems and methods described herein, preferably interfaces with one or more intelligent barrier(s) to enable the intelligent barrier(s) to make an entry decision. Additionally, in certain configurations, the portable device is interfaced with the computer software and database system. This configuration enables a user to exchange data needed to control, monitor or analyze access within a controlled area and/or zone of interest.

The intelligent barrier can be in the form of a gate, turnstile, door, swing gate, or similar assembly or mechanism that is capable of exchanging data with the portable device. The intelligent barrier processes data presented by the portable device to determine the identity of the person seeking entry into a zone of interest and whether that person possesses all administrative criteria and permissions needed for entry. Additionally, the intelligent barrier is also preferably capable of transmitting information to the portable device. The intelligent barrier is also preferably provided with area condition monitoring features that assist in making entry decisions. For example, feedback from radiation monitoring devices associated with the zone of interest and which are in communication with the intelligent barrier may enable the intelligent barrier to restrict access if area conditions have deteriorated. Additionally, in certain preferred configurations, all intelligent barriers in the system are capable of interfacing with a computer software and database system.

The computer software and database system interfaces with all of the portable devices and preferably also with all of the intelligent barriers within the system. The computer software and database system contains information related to personnel, zones, qualifications, work permits, administrative prerequisites, and administrative permissions.

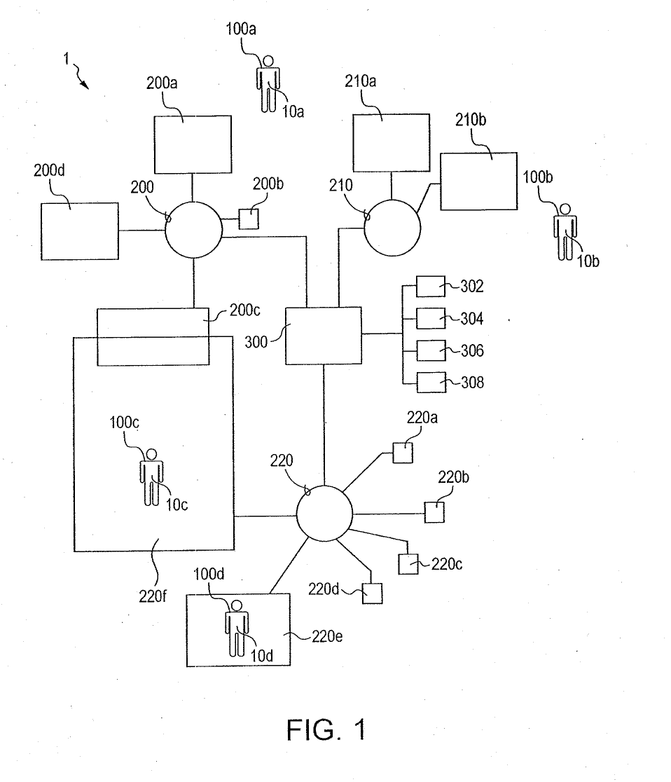

FIG. 1 is a schematic illustration of a preferred embodiment system 1 in accordance with the present invention. The preferred embodiment system 1 comprises one or more portable devices such as 100a, 100b, 100c, and 100d. Each portable device is typically carried, worn, or otherwise transported on a user such as user 10a, 10b, 10c, and 10d, respectively. Thus for example, the user 10a typically carries or wears the portable device 100a. The portable devices are provided with information pertaining to the individual to whom the device is assigned. Such information may include the name and/or other identifying information concerning the particular individual; physical, health, and/or medical information pertaining to the individual; security and administrative clearances associated with the individual; and background or job responsibility information for the individual. Examples of administrative clearances are provided herein and can include for instance, certain administrative prerequisites or particular administrative permissions. The information may also include data pertaining to the particular zone(s) of interest. This information for example can relate to the security level(s) required for entry into the zone, number of personnel allowed into the zone, times or time periods associated with entry and the like. A prime example of information that may be provided or otherwise stored or used in the portable devices is a Radiation Work Permit. These permits are typically used in the nuclear industry to determine whether access is to be granted to a radiation area. The portable devices can also use other types of electronic permits. Generally, any type of electronic permit utilized in a hazardous or sensitive area access scheme for controlling entry, exit, and other functions, can be used in conjunction with the portable devices of the present invention system.

The system 1 also comprises one or more intelligent barriers such as intelligent barriers 200, 210 and 220. Each intelligent barrier is associated with one or more controlled areas, such as controlled areas 200a, 200b, 200c, and 200d, which are associated with the barrier 200; controlled areas 210a and 210b which are associated with the barrier 210; and controlled areas 220a, 220b, 220c, 220d, 220e, and 220f which are associated with the barrier 220. For example, the intelligent barrier 200 may be in the form of a selectively sealable and lockable doorway that governs access to the one or more of the controlled areas 200a, 200b, 200c and 200d, which can for example be rooms or enclosed areas. It will be appreciated that a particular intelligent barrier may be designated for only a single controlled area, only a portion of a controlled area, or for multiple controlled areas. In addition, a controlled area associated with one barrier may include a portion or an entirety of a controlled area associated with another barrier. An example of this arrangement is depicted in FIG. 1 in which the controlled area 200c associated with the intelligent barrier 200 intersects a portion of the controlled area 220f associated with the intelligent barrier 220. Furthermore, it will be appreciated that a controlled area associated with one barrier may be entirely within a controlled area associated with another barrier. The present invention includes nearly any combination of arrangements of controlled areas and their associated intelligent barriers. The intelligent barriers include provisions for data communication with the portable devices 100a, 100b, 100c, and 100d, and preferably with a computer system described in greater detail herein. The intelligent barrier(s) may also include electronic control and data processing, management, and storage provisions. Such provisions enable the barriers to be selectively operated and utilized in the various systems described herein.

The system 1 also comprises one or more information collection and processing components such as a computer system 300. The computer system 300 includes one or more programs and/or databases for processing information and executing instructions as described in greater detail herein. The computer system 300 preferably includes provisions for data communication with the intelligent barriers 200, 210, and 220, and preferably also with the portable devices 100a, 100b, 100c, and 100d. Additional details and preferred aspects of the communication between the various components are provided in greater detail herein. The computer system 300 is preferably in the form of a microprocessor-based electronic computing system as known in the art. The computer system 300 preferably includes provisions for receiving operator inputs such as a terminal and/or a keyboard or keypad through which an operator enters instructions, information or the like. The computer system 300 preferably also includes provisions for providing one or more outputs or driving operator interface devices such as a monitor 302, a printer 304, and receiving inputs from operator interface devices such as a keyboard 306 and mouse or similar device 308. Examples of other types of input devices include, but are not limited to, joysticks, image scanners, webcams, graphics tablets, and microphones. Examples of other types of output devices include, but are not limited to, loudspeakers and signal or warning indicators. Various disc drives may constitute either input devices or output devices. The present invention includes a wide array of other components and accessories for the computer 300. Preferably, the computer system includes (i) input provisions for receiving information from at least one of the collection of portable devices and the at least one intelligent barrier, (ii) processing provisions for executing one or more algorithms using the received information, and (iii) output provisions for providing operating instructions to one or more of the intelligent barrier(s) according to the algorithms. It will be appreciated that in a most preferred aspect, the computer system receives information from both of the intelligent barrier(s) and the portable device(s) of interest, and that information is then assessed by the computer in deciding whether to allow access into the zone of interest. Additional details of each of the three components and their operation are provided herein.

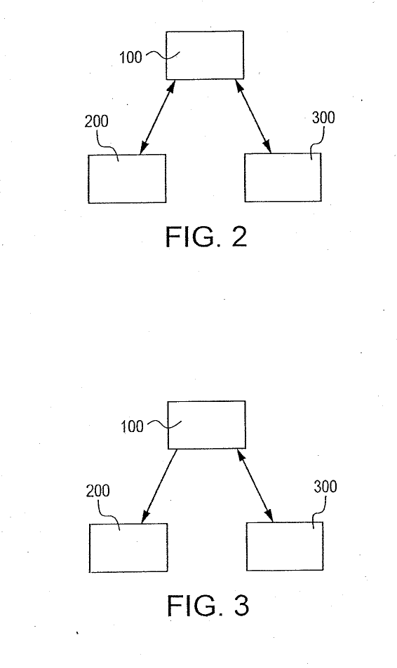

FIG. 2 is a block diagram schematically illustrating a communication configuration between the components of the present invention. In this configuration, bidirectional communication can occur between the portable device(s) 100 and the computer 300. And, bidirectional communication can also occur between the intelligent barrier(s) 200 and the portable device(s) 100. However, in this configuration, no direct communication occurs between the intelligent barrier(s) 200 and the computer 300.

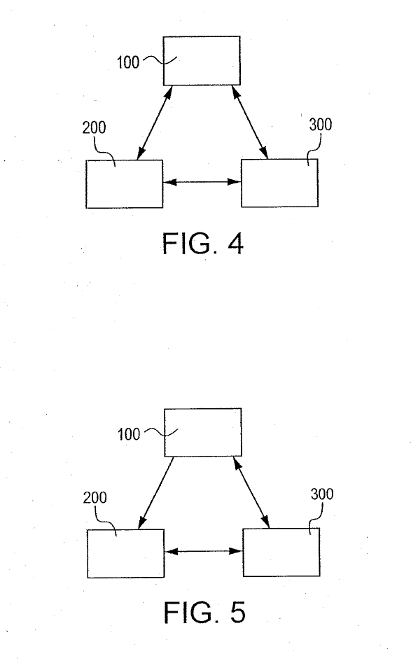

FIG. 3 is a block diagram schematically illustrating another communication configuration between components of the invention. In this configuration, bidirectional communication can occur between the portable device(s) 100 and the computer 300. Unidirectional communication can occur between the portable device(s) 100 and the intelligent barrier(s) 200, and in particular from the portable device(s) 100 to the intelligent barrier(s) 200. And, no direct communication occurs between the intelligent barrier(s) 200 and the computer 300.

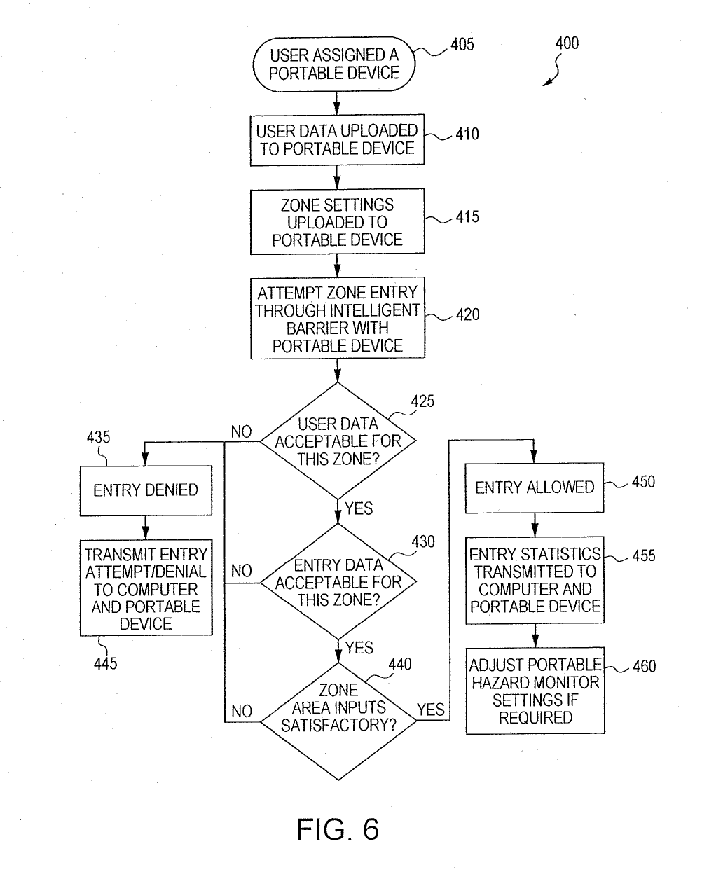

FIG. 4 is a block diagram schematically illustrating yet another communication configuration between components of the present invention. In this configuration, bidirectional communication occurs between the portable device(s) 100 and the computer 300; the portable device(s) 100 and the intelligent barrier(s) 200; and the intelligent barrier(s) 200 and the computer 300.

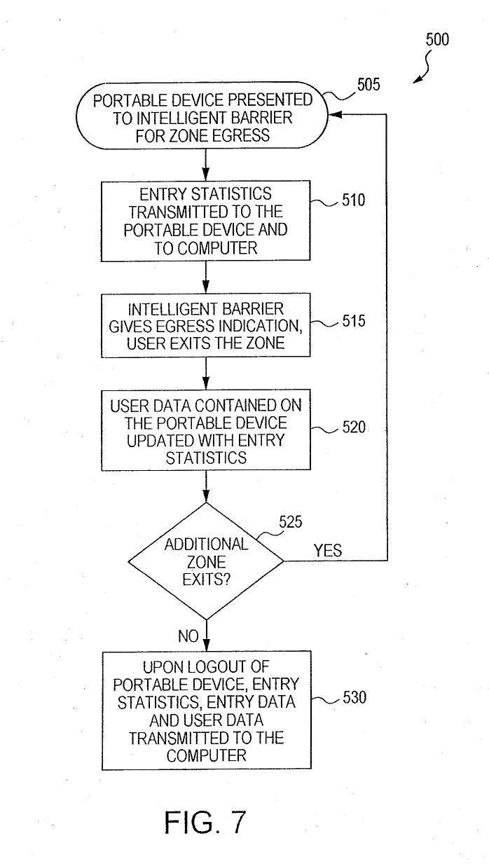

FIG. 5 is a block diagram schematically illustrating yet another communication configuration between components of the present invention. In this configuration, bidirectional communication occurs between the portable device(s) 100 and the computer 300; and the intelligent barrier(s) 200 and the computer 300. And, unilateral communication occurs from the portable device(s) 100 to the intelligent barrier(s) 200.

Communication can be established in nearly any manner and using any format that is acceptable for the facility or application of interest. As will be appreciated, data is typically stored and transmitted in digital form. Typically, communication is wireless, hard wired, or optical-based. Data transmission can be in any form, however, security and safety concerns typically dictate encryption or other safeguards of the data being implemented.

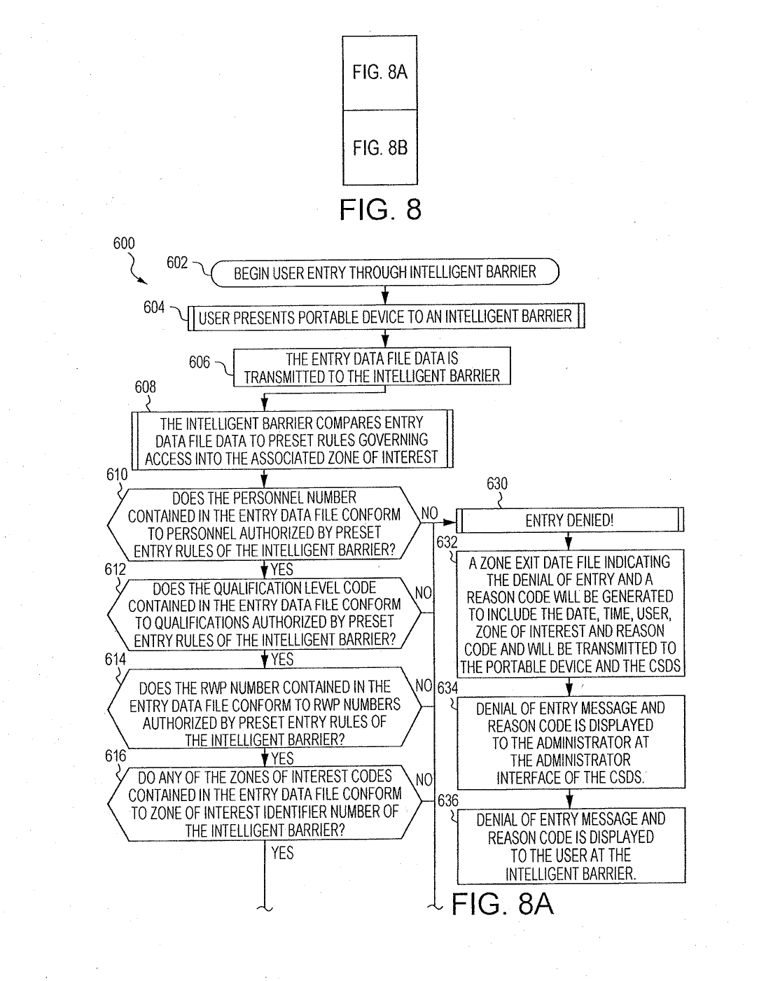

The present invention also provides various methods, techniques, and strategies for controlling one or more zone(s) of interest and particularly, controlling entry into and exit from a zone of interest. FIG. 6 is a flowchart illustrating a preferred embodiment process 400 for controlling access into a zone of interest, in accordance with the present invention. The process 400 includes an operation of assigning a portable device to a user, designated as step 405. User data is then uploaded or otherwise transferred to the portable device, in step 410. For example, data pertaining to the controlled area(s) which the user may access, past cumulative exposure levels of the particular user, and security clearances associated with the user may be transferred to the portable device. In operation 415, data associated with the one or more zone(s) of interest is uploaded to the portable device. Examples of such data can include, categories of personnel permitted in the zone(s), maximum time periods permitted in the zone(s), and security clearances or other requirements needed to enter the zone(s). Once the portable device is properly configured after receiving the information in steps 405, 410, and 415, an entry attempt into the zone(s) of interest through an intelligent barrier is performed, shown as step 420. The intelligent barrier and in certain embodiments, in conjunction with the computer system, then assesses whether the user associated with the particular portable device is permitted entry into the particular zone(s) of interest. This is shown as operation 425. If from operation 425, the user data is deemed acceptable for the particular zone(s) of interest, then the intelligent barrier and preferably in conjunction with the computer system, assesses whether entry into the zone(s) of interest is permitted. This is shown as operation 430. If from operation 425, the user data is deemed to not be acceptable by the intelligent barrier and preferably in conjunction with the computer system, then in operation 435, entry into the zone(s) of interest is denied. In operation 430, the intelligent barrier and preferably in conjunction with the computer system, assesses whether data and conditions are such that entry into the zone(s) of interest is permitted. If entry is determined to be permitted from operation 430, then zone area conditions are assessed in operation 440. If entry is determined to not be permitted, entry is denied in operation 435. In operation 440, the intelligent barrier and preferably in conjunction with the computer system determines whether sensed conditions within the zone(s) of interest are satisfactory. If not, entry is denied in operation 435. In the event of any denial of entry at operation 435, the occurrence of an entry attempt and one or more entry denial(s) are transmitted by the intelligent barrier to the portable device and in certain configurations, to the computer system as noted in operation 445. Assuming entry to the zone(s) of interest is allowed in operation 450, entry data and statistics are transmitted to one or both of the computer and the portable device in operation 455. At some point in the process 400, one or more settings or data associated with the portable device can be modified or otherwise adjusted to account for entry by the user into the zone(s) of interest. This is shown as operation 460.

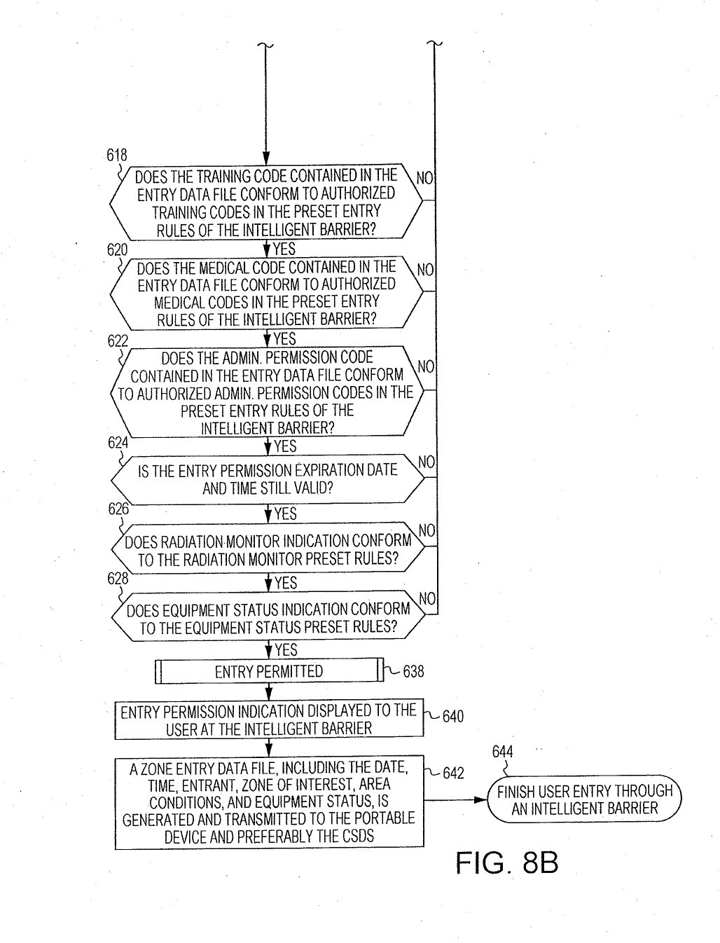

FIG. 7 is a flowchart illustrating a preferred embodiment process 500 in accordance with the present invention for controlling exit from one or more zone(s) of interest. As a user attempts to exit a zone, the portable device previously assigned to him or her is presented to the intelligent barrier, designated as step 505. Information such as entry statistics and other data is transmitted from the intelligent barrier to the portable device and preferably to the computer. This is shown as operation 510. In operation 515, the intelligent barrier provides indication for exiting the zone(s) of interest, and the user then exits the zone(s). Information from the portable device may be updated with entry statistics in operation 520. In the event that exit from additional zone(s) is desired or necessary, the process is repeated as shown via 525, beginning at step 505. If not, the portable device is subsequently logged out of the active system in operation 530. This log out may entail transferring entry statistics, entry data, and user data to the computer system and optionally to the intelligent barrier(s).

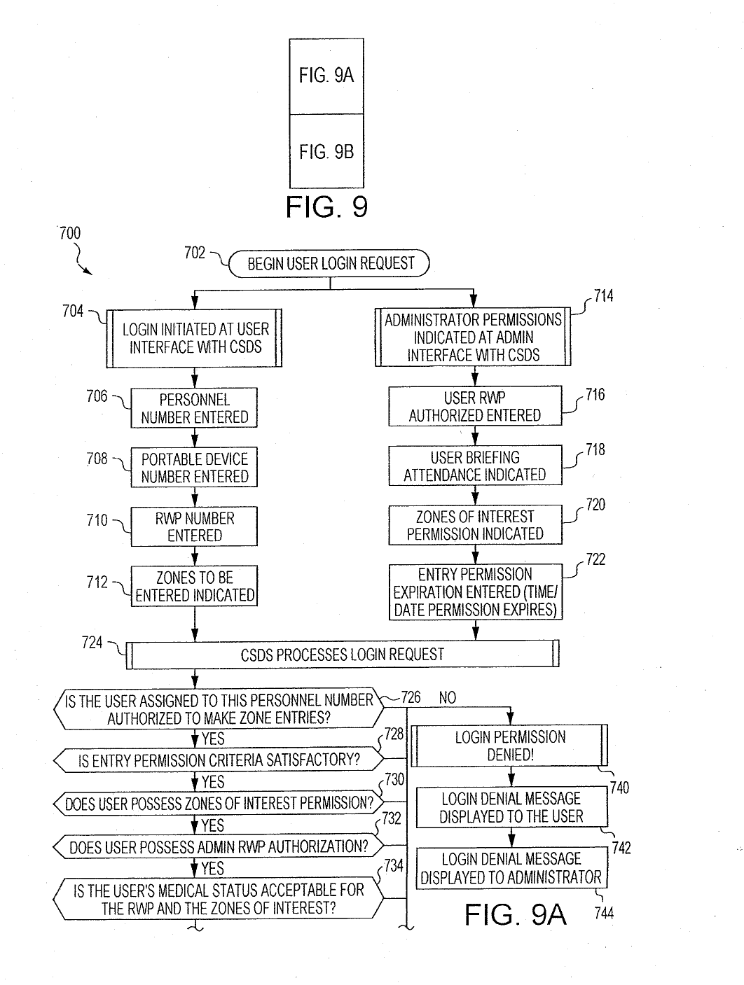

FIG. 8 is a flowchart illustrating a preferred embodiment process 600 in accordance with the present invention for entering a zone of interest using the preferred system. The preferred process 600 is initiated when a user approaches an intelligent barrier, such as 602. The user then presents their portable device to the intelligent barrier as designated by 604. In operation 606, an entry data file stored on and/or transmitted by the portable device is transmitted to the intelligent barrier at 606. In 608, the intelligent barrier compares the entry data file to preset rules or criteria governing access into the particular zone of interest. A series of checks or comparisons are then performed. The following is an exemplary description of such comparisons. It will be appreciated that the preferred process 600 is not limited to this particular order of comparisons. At 610, the personnel number in the entry data file is assessed to determine if that number conforms to a class of personnel authorized for the particular zone. The personnel class information is preset and administered via entry rules of the intelligent barrier. If not, entry is denied at 630. If the personnel number is authorized for entry into the zone of interest at 610, the intelligent barrier (or system) in step 612, then assesses whether the qualification level code contained in the entry data file conforms to qualifications authorized by the intelligent barrier (or system). If not, entry is denied at 630. If so, then in step 614, an assessment is performed whether the Radiation Work Permit (RWP) number in the entry data file conforms to such numbers for the zone, authorized by the intelligent barrier (or system). If not, entry is denied at 630. If so, another assessment at 616 is made as to whether any of the zones of interest codes contained in the entry data file conform to a zone of interest identifier of the intelligent barrier (or system). If not, entry is denied at 630. If so, another assessment at 618 is performed whether the training code contained in the entry data file conforms to authorized training codes in the preset entry rules of the intelligent barrier (or system). If authorization is given, another assessment at 620 is performed as to whether any medical codes contained in the entry data file conform to authorized medical codes in the preset entry rules of the intelligent barrier (or system). If no such authorization is determined, entry is denied at 630. If such authorization is given, another assessment at 622 is performed. At 622, one or more administrative permission codes contained in the entry data file are assessed based upon authorized administrative permission codes in the preset entry rules of the intelligent barrier (or system). If such codes are determined to not be permitted access into the zone, entry is denied at 630. If such codes are authorized, another assessment at 624 is performed as to whether the entry permission expiration date and time are valid. If not, entry is denied at 630. If such time and date are determined to be valid, another assessment at 626 is performed. In this assessment at 626, a determination is made whether a radiation monitor indication conforms to corresponding rules preset in the intelligent barrier (or system). If not, entry is denied at 630. If such conformance is assessed, another determination at 628 is performed as to whether an equipment status indication conforms to corresponding rules preset in the intelligent barrier (or system). If not, entry is denied at 630. If such conformance is assessed, entry by the intelligent barrier into the zone of interest is permitted at 638.

For one or more states in which entry is denied at 630, a zone exit data file indicating the denial of entry and a reason code are generated as designated by 632. The information preferably includes the date, time, and user. The information including the zone of interest and the reason code is transmitted to the portable device and to the computer and software database system (CSDS). Preferably, at 634, a denial of entry message and associated reason code(s) are displayed to the administrator at the administrator interface. And, preferably, at 636, the denial of entry message and reason code(s) are displayed to the user at the intelligent barrier.

Preferably, upon granting of entry into the zone of interest at 638, an entry permission indication is displayed to the user at the intelligent barrier as shown at 640. And, preferably, a zone entry data file including the date, time, entrant, zone of interest, area conditions, and equipment status, is generated and transmitted to the portable device and preferably to the computer and software database system as shown at 642. The user entry sequence is then completed at 644.

In accordance with the present invention, it is preferred that prior to a user attempting entry into a zone of interest, it is necessary that the user and in particular, the user's portable device be logged in to the system.

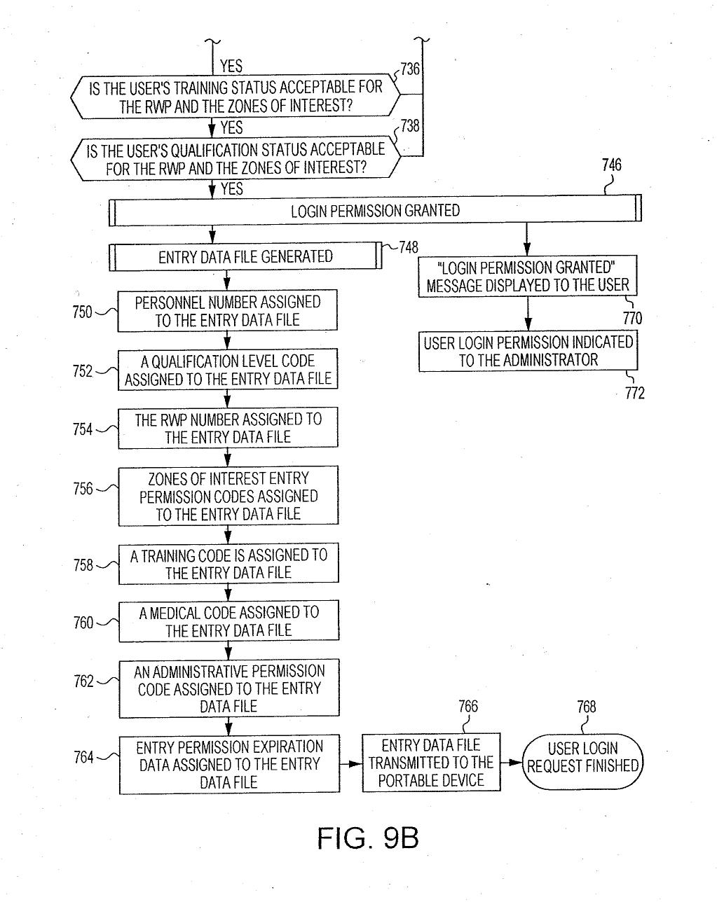

FIG. 9 is a flowchart depicting a preferred embodiment process 700 in accordance with the present invention for initiating and performing a system login sequence. At 702, the user login request is initiated. At 704, the login is initiated at a user interface with the computer software and database system (CSDS). This involves entering a personnel number associated with the user, as designated by 706. One or more numbers or identifiers associated with the portable device are then entered, at 708. A Radiation Work Permit (RWP) number is entered, at 710. And, the particular zones that the user may enter are entered at 712. Additional information, preferably supplied and/or entered at an administrator level are also entered such as particular administrative permissions at 714. Also, authorizations for the Radiation Work Permit (RWP) for the particular user are entered at 716. User briefing attendance can also be entered at 718. The associated zones(s) of interest for which entry is authorized for that user are entered at 720. And, entry permission expiration time and date information is entered at 722. Upon receipt of the foregoing information, the computer and software database system processes the login request at 724. In step 726, the system assesses whether the user assigned to the noted personnel number is authorized to enter the noted zones. If not, login permission is denied at 740. If determined satisfactory, an evaluation is performed at 730 as to whether the user possesses zone(s) of interest permission. If not, entry is denied at 740. If yes, another assessment is made at 728 as to whether the entry permission criteria is satisfactory. If not, login permission is denied at 740. If yes, another assessment is made at 732 as to whether the user possesses administrative Radiation Work Permit (RWP) authorization. If not, login permission is denied at 740. If yes, another assessment is made at 734 as to whether the user's medical status is acceptable for the Radiation Work Permit and the zone(s) of interest. If not, login permission is denied at 740. If so, another assessment is made at 736 as to whether the user's training status is acceptable for the Radiation Work Permit and the zone(s) of interest. If not, login permission is denied at 740. If yes, another assessment at 738 is made concerning whether the user's qualification status is acceptable for the Radiation Work Permit and the zone(s) of interest. If not, login permission is denied at 740. If yes, login permission is granted as shown at 746.

In the event of one or more states resulting in login permission being denied at 740, it is preferred that a login denial message and/or indication be displayed to the user, as designated at 742. It is also preferred that such state(s) be displayed or otherwise communicated to the administrator as shown at 744.

Upon login permission granted at 746, an entry data file is generated at 748. Pursuant to such, a personnel number corresponding to the user is assigned or incorporated in the file, at 750. A qualification level code is also assigned or incorporated in the file at 752. The particular Radiation Work Permit number is assigned or incorporated into the file at 754. One or more zone(s) of interest for which entry may be permitted is assigned or incorporated into the file at 756. A training code is assigned or incorporated into the file at 758. A medical code is assigned or incorporated into the file at 760. An administrative permission code is assigned or incorporated into the file at 762. And, entry permission expiration data such as dates and times, is assigned or incorporated into the file at 764. The resulting entry data file is then transmitted and/or stored to the portable device as depicted at 766. The user login request sequence ends as shown at 768.

It may be preferred upon granting login permission at 746, to display or otherwise communicate a “Login Permission Granted” message to the user, such as shown at 770. In addition, it may be preferred to indicate this condition to one or more administrators, such as depicted at 772. It will be appreciated that the preferred process 700 may take a variety of different forms and is not limited to the particular configuration depicted in FIG. 9.

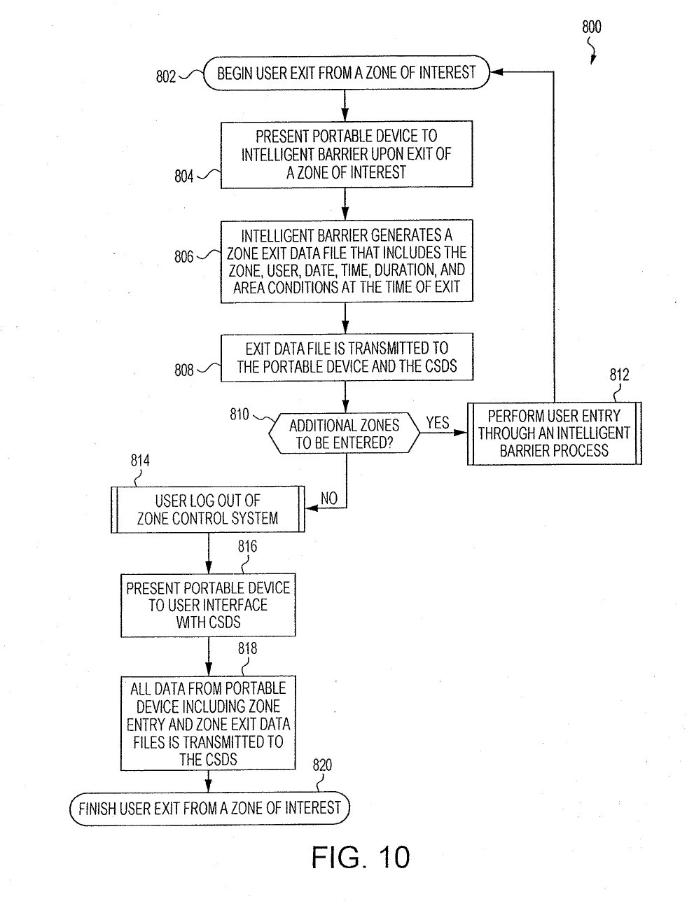

After a user enters a zone of interest, previously authorized by the process 600 illustrated in FIG. 8, the user will exit that zone. Preferably, process 800 depicted in FIG. 10 is performed. At 802, the exit process is initiated. Generally, the user presents their portable device to the associated intelligent barrier, as depicted at 804. At 806, the intelligent barrier generates a zone exit data file that preferably includes information pertaining to the zone, user, date, time, duration within the zone, and area or zone conditions at the time of exit. At 808, the exit data file is transmitted to the portable device and the computer and software database system. An assessment as to whether additional zones are to be entered is made at 810. If yes, in operation 812, a user entry process such as shown in FIG. 6 is performed to determine whether the user is authorized to enter the desired zone. If no other zone(s) are to be entered, the user performs a log out process from the system as shown at step 814. The user presents their portable device to a user interface of the system, as shown by 816. All data from the portable device including zone entry and zone exit data files are transmitted to the computer and software database system, as depicted by 818. The exit sequence is completed at 820. It will be understood that the preferred process 800 may take a variety of different forms and is not limited to the particular configuration depicted in FIG. 10.

Additional details of the portable devices, intelligent barriers, and computer system of the preferred embodiment systems are as follows. Also provided are various examples of different operating scenarios.

### Portable Devices

The portable device component used in the preferred embodiment systems and methods primarily serves to provide identification and/or verification of the individual carrying or possessing the device. Preferably, the portable devices are electronic, microprocessor-based, programmable, and include memory provisions for storing data which may be in the form of nonvolatile and/or volatile RAM, an onboard power source, and may optionally include operator input touch pads, key pads, or other input receiving components, and operator output displays, drives, or other output provisions. An example of a user identifying portable device is a programmable electronic dosimeter that is commonly used in the nuclear industry. Other examples of portable devices that are suitable for use in the present invention systems and methods include, but are not limited, to programmable identity badges or an alternative hazardous monitoring device, all capable of carrying and exchanging data. Programmable data assistants (PDA's) and other portable computing and data storage devices are also contemplated. These are less practical but feasible examples of user identifying portable devices that can be used in the invention.

Preferably, data from the portable device interfaces with intelligent barriers to enable the intelligent barrier(s) to make an entry decision. Additionally, the portable device is capable of interfacing with a computer software and database system to exchange data needed to control, monitor or analyze access within hazardous areas by the user of the portable device.

An example of a commercially available portable device suitable for use in the present invention is an EPD MK2+Electronic Personal Dosimeter available from Thermo Scientific of Thermo Fisher Scientific Inc. of Waltham, Mass. Another example of commercially available dosimeters for use as a portable device in the present invention are those available under the designations DMC 2000 and SOR from Mirion Technologies of San Ramon, Calif. It is also contemplated to use portable data assistants (PDAs) or smart phones that are appropriately configured to receive data, process, and interface with other components in the system. An example of a suitably configured portable device is a device such as the previously noted EPD MK2+ or EPD-N device configured with software available under the designation EasyPDA from Thermo Scientific. It will be appreciated that in no way is the present invention limited to these particular representative examples.

### Intelligent Barriers

As previously noted, the intelligent barrier component can be in the form of a lockable gate, turnstile, door or similar assembly or mechanism that is capable of exchanging data with the portable device, and preferably with the computer system. The intelligent barrier receives and processes data presented by the portable device to identify the individual seeking entry and whether the individual possesses all administrative rules and permissions needed for entry. Examples of such rules and permissions include, but are not limited to, whether a pre-job brief has been performed, whether a worker has requisite training on record, whether specific permission to a particular area has been given, and whether a particular radiation work permit allows entry to an area. These can be indicated by data programmed or transferred into the user identifying portable device. Data from the portable device that conforms to preset conditions may also cause the intelligent barrier to grant entry to the area.

Additionally and preferably, the intelligent barrier is also capable of transmitting information to the portable device. Details such as time of entry, duration and total number of entries by a particular user can be transmitted and stored by the portable device.

Preferably, the intelligent barrier also includes memory provisions for storing information and/or data. The memory provisions may be in the form of nonvolatile and/or volatile RAM, optical based memory provisions, and other memory media formats.

And, the intelligent barrier also preferably includes electronic processing and computing provisions for processing information, data, operator instructions or the like. Examples of such information and data include but are not limited to, information stored in the memory provisions of the intelligent barrier, information from the computer software and database system, information from an external source, and/or information obtained from the area(s) of interest.

Additionally, the intelligent barrier is preferably enabled with area condition monitoring features that assist in making entry decisions. For example, feedback from radiation monitoring devices connected to the intelligent barrier enable the intelligent barrier to restrict access if area conditions have deteriorated.

Additionally and preferably, all intelligent barriers in the system are capable of directly interfacing with the computer software and database system. This enables a network administrator to determine various matters such as the number of people in each area, the length of time that each person has been in a selected area, which areas indicate unauthorized entry attempts by which users, and which area and/or devices are to restrict entries due to deteriorated area conditions.

Additionally, the intelligent barriers may be configured to operate in a stand alone mode that does not require an active connection to a computer software and database system. In this mode, the administrator can locally program the intelligent device with access criteria, thereby requiring only the interface of the portable device with the intelligent barrier.

Additionally, the intelligent barrier device may be portable so that it can be deployed to any location desired by an administrator. This would facilitate access control for areas that are temporarily hazardous or for areas where the conditions change from benign to hazardous.

Examples of commercially available intelligent barriers include an appropriately configured Hi-Rad Gate available from Innovative Industrial Solutions of Russellville, Ark.; turnstiles with ACU available from Thermo Scientific; a securable door assembly operated by an Access Control Reader ACT 6 from Thermo Scientific; securable doors or other access points operated by a pass by data exchange device available from Mirion Technologies under the designation LDM 2000; and other barriers configured with a dosimeter reader such as LDM 3000 available from Mirion. Again, it will be appreciated that in no way is the invention limited to these particular representative examples of intelligent barriers.

### Computer Software and Database System

The computer system component includes input provisions for receiving information from the portable devices and/or the various intelligent barriers. These input provisions can for example be input and data storage registers or partitioned memory provisions. The computer system also includes processing provisions for executing one or more algorithms. The processing provisions can be in the form of one or more microprocessors or other computing components. The computer system also includes output provisions for operating or at least controlling operation of the barriers and in certain configurations, the portable devices. The output provisions are preferably in the form of data or signal outputs which are transmitted to the network or to the individual component(s) of interest.

The computer software and database system preferably interfaces with all of the portable devices, and all of the intelligent barriers within the system. Several types of interfacing may occur as follows.

In one interfacing configuration, the computer system transmits data to portable devices. Upon user login with his or her portable device, the computer software and database system transmits data to the portable device which can be read by the intelligent barriers. Examples of this data include the administrative prerequisites such as training, formal briefs or Radiation Work Permit (RWP) authorization needed to grant entry into a specific area.

In another interfacing configuration, the computer system receives data from the portable devices. Upon user logout of his or her portable device, the computer software and database system receives data from the portable device containing information such as the location, number, time and duration of entries.

In another interfacing configuration, the computer system transmits data to the intelligent barriers. The computer software and database system transmits information through a data connection to the intelligent barrier such as zone access criteria. Zone access criteria may include a hazard class designation of the area such as a High Radiation area or a Very High Radiation Area (VHRA). Zone access criteria may include acceptable area conditions for entry as determined by the area monitors connected to the intelligent barriers. Zone access criteria may include the administrative prerequisites needed by the entrant such as authorization on a particular work permit or the possession of required training or the indication the user received a formal brief. The computer software and database system administrator may also manually enable or disable all entry through an intelligent barrier within the system. Typically, this capability would exist in the system configurations illustrated in FIGS. 1 and 4.

In another interfacing configuration, the computer system receives data from the intelligent barriers. Examples of this information include how many people are currently in each area, how long have people been in a selected area, what time was a particular entry made, which areas indicate unauthorized entry attempts by which users, what are the area conditions as measured by hazard monitoring devices, and which areas devices are restricting entries due to deteriorated area conditions.

A wide array of computing devices and systems can be used such as one or more personal computers which may for example use 16-bit, 32-bit, or 64-bit processors in a wide range of commercially available hardware configurations. The computer system can use nearly any appropriately tailored operating system as known in the art.

The methods and systems described herein preferably utilize one or both of the following two configurations. In a first preferred configuration, a central computer or computer and database system provides all decision-making functions to the intelligent barriers. In a second preferred configuration, the intelligent barrier(s) include memory provisions and electronic processing provisions such that the intelligent barrier can also undertake one or more decision-making functions. Thus, in the second preferred configuration, the decision-making functions are performed by the central computer or computer and database system, and the intelligent barrier(s). It is even contemplated that all decision-making functions could be performed by the intelligent barriers if the barriers were appropriately equipped such as with the noted memory provisions and processing provisions. In this latter configuration, although the central computer system would not be used in the noted decision-making functions, the computer system might still be used for monitoring, operational backup, collecting and archiving of information, and/or warning or shutdown procedures.

### Additional Features

### Unique Access Devices

In the preferred embodiment systems and methods, one or more additional devices may be used to aid in governing control, access and entry to particular zones of interest. Examples of such devices include programmable turnstiles, swing gates, doors, and signs. These are used to discriminate access based on user manual inputs, automatic inputs or local condition changes.

### Entrant Monitoring

The intelligent barrier can be configured to enable entrant monitoring devices to activate upon entry to a hazardous area. When an entrant enters through the intelligent barrier, a camera or monitoring device can be enabled to activate and monitor the entrant's activities in real time.

An example of such monitoring devices includes a battery powered camera that is activated only when entrants are present within an area thereby saving battery power when the area is not in use.

Another example of such monitoring devices is a real time feedback of radiation conditions measured by a user's electronic dosimeter transmitted to the computer software and database system. This enables the administrator to understand which areas the entrant is in and what conditions the entrant is experiencing while in those areas. Additionally, the additional power requirements needed by the electronic dosimeter to wirelessly transmit this real time information can be limited to only the time the entrant is inside a predefined hazard area such as a Very High Radiation Area.

### Remote Changeable Intelligent Barrier Hazard Level

The criteria for access into radiologically significant areas may also be changed locally or remotely as needed by the administrator. For example, the administrator may upgrade a High Radiation area to a Very High Radiation Area with the new entry criteria reflected by the intelligent barrier. Additionally, the display of the new hazard class may also be changed so that an entrant will read the new designation of the area at the intelligent barrier. This eliminates the need to have radiation protection personnel manually change signage, or locks to reflect new radiological risk levels.

### Changeable Dosimeter Settings

The present invention also provides an intelligent barrier device that transmits area specific radiation dose rate settings and dose accumulation settings to a portable user identifying radiation dosimeter. This allows the settings of an electronic dosimeter to be modified to accommodate conditions in the specific area controlled by the intelligent barrier device.

For example, electronic dosimeter settings may be increased to facilitate work within a particular area. The intelligent barrier can reconfigure the settings of the electronic dosimeter to accommodate work while in this area. The intelligent barrier can then reduce the setpoints back to a lower level when the entrant exits the area through the intelligent barrier.

### Real Time Monitoring Enabled Upon Entry

The invention also provides an intelligent barrier device that enables video monitoring upon the detection of entrants. Another form of monitoring is the provision of an intelligent barrier device that will log and report in real time the number and total entrants within a zone of interest.

### Requisite Personnel Must be Present to Allow Entry

In another aspect, the present invention can be configured such that a particular area or zone of interest may require an administrator to have entrants accompanied by a qualified technician. In such applications, the intelligent barrier can be configured to only allow access to the area when a qualified technician has entered the area.

For example, a facility complying with regulations that state workers in a VHRA must be accompanied by a qualified technician, can utilize a preferred embodiment system that is appropriately configured. The intelligent barrier will not let anyone enter the area unless a qualified technician has first entered or has otherwise authorized the entry.

### Real Time Monitoring of Personnel can Affect Subsequent Entries

Entrants that are monitored in real time by personally assigned monitoring devices (as opposed to monitoring devices that are directly connected to the intelligent barrier) can affect subsequent entries based on the readout of their personal devices.

Radiation example: For example, one or more workers enter an area. Upon entry the intelligent barrier programs their dosimeters to transmit its measurements in real time to either the intelligent barrier directly or the computer software and database system. When one of the workers encounters unanticipated radiation levels, all subsequent entries are rejected (unless the entrant is qualified to respond to such an event, i.e. a technician).

Non Radiation example: A confined space entrant's personally assigned flammability monitor indicates an adverse condition. This prevents anyone but rescue personnel from entering the area.

Alternate Non Radiation feature: Confined space entries allowed only between checks. A confined space may need to be periodically checked to ascertain conditions. The intelligent barrier can be configured to only allow entries to the area during the time period between checks. If a confined space must be rechecked every 12 hours, entry within those 12 hours will be permitted and entries after the 12 hour period will be rejected until a technician checks the area and conveys this to the intelligent barrier through one of the other elements of the system.

### Unique Access Devices

Specially designed intelligent barriers may be utilized to aid in the specific implementation of the methods described herein. An example of such devices would be programmable and portable turnstiles; programmable and portable swing gates; programmable and portable door mechanism i.e. a door and door frame affixture that can be attached to an existing door/doorframe thereby transforming them into an intelligent barrier device described herein; and smart signs (signs that will indicate a permissible entry).

### Plant Configuration Inputs

Plant configuration may also be an input into any radiological access control process. Radiation levels in certain areas may change dramatically if plant equipment is reconfigured. Entry to these areas can be coordinated with plant operations to regulate access dependent upon the proper plant configuration.

Radiation example: A room has a low radiological risk but may change as nuclear fuel in the vicinity is moved. An intelligent barrier can reject an attempted entry based on the indication of an unsafe equipment configuration inputted to the intelligent barrier device. For instance, when fuel conveyance machinery is energized a sensor can provide indication to the intelligent barrier directly or to the computer software and database system connected to the intelligent barrier. The device would prevent access when a known unsafe plant configuration exists.

Non Radiation Example: Ventilation to a confined space is required to remain active. Upon the failure of the ventilation flow sensor within the area, a signal is transmitted to the intelligent barrier either directly or indirectly via the computer software and database system. This signal prevents future entries and signals an alarm to any/all devices within the system, i.e. it causes a local alarm at the intelligent barrier, an alarm on all interfacing personal monitoring devices present in the area, and an alarm on the computer software and database system.

### Area Conditions Alarming Feature

Any adverse conditions or adverse equipment configurations detected can cause a local alarm at the intelligent barrier, an alarm on all interfacing personal monitoring devices present in the area, and an alarm on the computer software and database system.

### Radiation Level Access Control

Intelligent barriers can be used along with local radiation measuring devices to change access permissions based on actual measured radiation conditions. For example, an area may be assumed to be of lower radiological significance. However due to unforeseen changes, the actual radiation conditions may warrant higher levels of control and permissions than is implied and denoted by the boundary signs and access points. Entry into the area as it is posted would inadvertently allow workers to encounter radiological hazards that they are not permitted to access. The licensee in this case may not have known the conditions have changed. However, an intelligent barrier device used with a radiation monitoring device would restrict entry when conditions have changed significantly as measured by the radiation monitoring device.

### Remote Changeable Intelligent Barrier Permissions

The criteria for access into radiologically significant areas may also be changed, locally at the intelligent barrier or remotely via a computer software and database system connected to the intelligent barrier, as needed by the administrator. This would eliminate the need to have radiation protection personnel manually change signage, or locks to reflect new radiological risk levels.

### Passive Barrier Control Using Alarms and Indication

Intelligent barrier devices can be configured to always allow operation of the barrier. For example, for safety reasons an access point may be required to allow entry and exit at all times. However, if the entrant attempts to enter without proper authorization the intelligent barrier device can signal an alarm (local and remote).

The present invention also provides computer programs, algorithms, or software that conducts a set of instructions to perform one or more of the previously described access, entry, and/or exit control methods. In a preferred embodiment, the present invention provides a method, performed by use of a computer or other electronic processing unit, to govern and/or monitor access to a zone of interest.

The present invention also provides computer readable media that comprises programs or algorithms that perform one or more of the previously described methods; and the previously described preferred method using a computer. Examples of computer-readable media may be any available media, which is accessible by a general purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general purpose or special purpose computer system.

In this description, a network or computer network is defined as one or more data links that enable the transport of electronic data between computer systems, processing units and/or modules. When information is transferred or provided over a network or another communications connection (either hardwired, wireless, or a combination of hardwired or wireless) to a computer system, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general purpose computer system or special purpose computer system to perform a certain function or group of functions. The computer executable instructions may be, for example, binaries, intermediate format instructions such as assembly language, or even source code.

In this description, a computer system is defined as one or more software modules, one or more hardware modules, or combinations thereof, that work together to perform operations on electronic data. For example, the definition of computer system includes the hardware components of a personal computer, as well as software modules, such as the operating system of the personal computer. The physical layout of the modules is not important. A computer system may include one or more computers coupled via a network. Likewise, a computer system may include a single physical device (such as a mobile phone or Personal Digital Assistant “PDA”) where internal modules (such as a memory and processor) work together to perform operations on electronic data.

### Examples of Use

### Example 1

### The Successful Entry

An example of successful entry into a zone or area of interest is a worker who has met the administrative prerequisites and received permission to enter a specific “Level 1” radiation area at location “B”. This worker obtains a portable, user identifying device which, upon login, is automatically programmed to contain all the administrative information permitting his entry into a “Level 1” area located at location “B”. This worker attempts to gain entry into a Level 1 High Radiation at location “B” by presenting his user identifying portable device (in this case, a personally assigned portable radiation measuring device) to the intelligent barrier at location “B”. The intelligent barrier at location “B” reads data on his user identifying portable device and determines the worker is allowed to enter as indicated by a green light illuminated on a turnstile.

### Example 2

### Wrong Area—Denied

An example of denial of entry is a worker attempting to enter a Level 2 High Radiation Area at location “C”. The worker presents his or her user identifying portable device to the intelligent barrier which correctly determines the worker has the administrative perquisites for a Level 2 Area. However, he or she does not have specific permission to enter location “C” and therefore his or her entry is rejected as indicated by a red light and a remote indication on the licensee's computer software and database system.

### Example 3

### Area Conditions Changed—Denied

Another example of denial of entry is a worker attempting to enter a Level 1 High Radiation Area at location “B”. He or she presents their user identifying portable device to the intelligent barrier which correctly determines the worker has the administrative perquisites for a Level 1 Area and specific permission to enter location “B”. However, an area hazard monitoring device (in this case a radiation monitor) inputted to the intelligent barrier indicates the presence of conditions that exceed a Level 1 High Radiation area and the entry is therefore rejected.

### Example 4

### Unauthorized Entry Attempt—Alarm

Another example of entry denial is a worker who disregards the indication of a rejection of entry and decides to operate the intelligent barrier. The intelligent barrier indicates an audible and remote alarm indicating an unauthorized entry attempt.

### Example 5

### Unsafe Equipment Active—Denied

Yet another example of entry denial is a worker attempting to enter a Level 1 High Radiation Area at location “B”. He or she presents their personally assigned portable radiation measuring device to the intelligent barrier which correctly determines the worker has the administrative prerequisites for a Level 1 Area and specific permission to enter location “B”, but an input to the intelligent barrier indicates equipment is energized that has the potential to change radiation conditions within the area and therefore rejects entry indicated by a red light.

### Example 6

### Entry Information Transmitted to Portable Device

An example of another situation is a worker returning from work inside three separate Level 2 High Radiation Areas. He or she presents their user identifying portable device to a data reading device that records the time, duration and frequency of entry into each Level 2 High Radiation Area.

### Example 7

### Radiation Hazard Class Redefined by the Administrator

Another example of a situation is an administrator who decides to change the level status of location B from a Level 1 High Radiation Area to a Level 2 High Radiation Area. The administrator utilizes the computer software and database system to communicate with the intelligent barrier to update the entry criteria commensurate with a Level 2 area. The intelligent barrier will now allow entry only when Level 2 criteria is met.

### Example 8

### Dosimeter Settings Reprogrammed Upon Entry/Exit

Another example of use of the system is an intelligent barrier that transmits and reconfigures area specific radiation dosimeter settings (or other hazard set points, i.e. flammability meter, O₂ levels . . . etc.) to a portable user identifying radiation dosimeter presented by a user. This allows the facility to adjust electronic dosimeter settings according to the area entered by workers by programming their intelligent barrier to readjust settings. Further, the settings can be readjusted upon exit.

### Example 9

### Technician Escort Needed—Denied

Another example of use of the system is a situation in which a worker attempts to enter a VHRA. He/she has all the required training and has attended the required briefing and has these indicated in the data on the personal device. However, the administrator has specified that all VHRA's require an escort by a qualified technician. The intelligent barrier is programmed to look for a qualified technician to enter the area first before an additional entrant may be allowed. Therefore the worker's entry attempt is rejected until a qualified technician enters first.

### Example 10

### Detailed Example of System in Use

The following is a representative example of using a preferred embodiment system in accordance with the present invention.

User Login Request—Using a software interface with a preferred embodiment Zone Control System, the user requests entry into one or more zone(s) of interest under a Radiation Work Permit. The user enters their personnel number. The user enters the portable device number. The user enters the desired Radiation Worker Permit (RWP). And, the user enters the Zone(s) of Interest (ZOI) to be accessed during this entry.

Administrator Permission Input—Using a software interface with the Zone Control System, the administrator enters the following indications associated with the user's entry. The administrator indicates administrative permission for the user to enter the appropriate ZOI. The administrator indicates administrative permission for the user to work under a specific RWP. The administrator indicates the user's attendance of a pre-job brief. The administrator enters entry limitations such as the total number of entries granted to the user, and the time the entry authorization expires.

Login Request Processing—The Computer and Software Database System (CSDS) processes the user login and administrator permission inputs by performing the following. The CSDS accesses user data related to the user's personnel number including training history and status, qualifications, and medical history and status. The CSDS compares the user login input and the administrator permission input to preset rules associated with the specific RWP and the ZOI indicated by the user during the login request. If the inputs conform to the preset rules governing the RWP and the ZOI, the login request is granted and an output data file is generated. If the inputs do not conform to the preset rules governing the RWP and the ZOI, the login request is denied and a denial message is displayed to the user interface and to the administrator interface.

Entry Data File—When a login request is granted, an Entry Data File related to the entry is generated. The Entry Data File may contain data related to the login request, administrator permissions, the RWP and the ZOI. For example, the Entry Data File may contain the following information:

| | |
|---|---|
| Personnel number = | 1125 |
| Qualification level = | 3 |
| RWP number = | 1004 |
| ZOI = | 1, 3, 5 |
| Training code = | 1057 |
| Medical code = | 2123 |
| Admin. permission code = | 3111 |
| Expiration = | 01/01/2010, 08:00 |

In this case, the Entry Data File indicates a successful login by the user associated with personnel number 1125, possessing a qualification level associated with the number 3, working under the RWP associated with the number 1004, with permission to enter zones 1, 3, and 5, possessing training prerequisites associated with code 1057, possessing medical prerequisites associated with code 2123, possessing administrative permissions associated with code 3111, and entry permission expiring on Jan. 1, 2010 at 08:00.

Upon successful login, the Entry Data File is uploaded to the portable device.

The user presents the portable device to the Intelligent Barrier controlling access to a Zone of Interest.

Intelligent Barrier/Portable Device Entry data File Processing—The Intelligent Barrier compares the Entry Data File contained on the user's Portable Device to its preset entry rules governing access into the associated Zone of Interest.

An example of such a comparison may be:

| Entry Data File | IB/ZOI Preset Entry Rules | Entry code |
|---|---|---|
| Personnel number = 1125 | Personnel Authorized: | Y |
| | 1124, 1125, 1126 | |
| Qualification level = 3 | Qualifications Authorized: | Y |
| | 1, 2, 3 | |
| RWP number = 1004 | Authorized RWP's: | Y |
| | 1001, 1002, 1003, 1004 | |
| ZOI = 1, 3, 5 | Zone Identifier: 3 | Y |
| Training code = 1057 | Authorized Training codes: | Y |
| | 1056, 1057, 1058 | |
| Medical code = 2123 | Authorized Medical codes: | Y |
| | 2122, 2123, 2124 | |
| Admin. permission code = 3111 | Authorized Admin. codes: | Y |
| | 3111, 3112, 3113 | |
| Expiration = 01/01/2010 08:00 | Current Date/Time: | Y |
| | 12/20/2009 13:00 | |

In this case, the Entry Data File conforms to each category of IB/ZOI Preset Entry rules resulting in a Satisfactory Entry code as indicated by a “Y” in each Entry code column.

Intelligent Barrier/Area Condition Monitor Processing—The Intelligent Barrier also consults connected area condition inputs to determine if entry is permitted. For example:

| Radiation | Current Radiation | Entry |
|---|---|---|
| Monitor Preset | Monitor indication | code |
| <100 millirem/hour | 2 millirem/hour | Y |

In this case, current radiological conditions measured by the radiation monitor are below the Radiation Monitor Presets, therefore area condition inputs permit an entry as indicated by a “Y” in the Entry code column.

Intelligent Barrier/Area Equipment Status Processing—The Intelligent Barrier also consults connected area equipment status inputs to determine if entry is permitted.

| Equipment Status Presets | Current Equipment Status | Entry code |
|---|---|---|
| Ventilation energized = Y | Ventilation energized = Y | Y |

In this case, the Equipment Presets require the ventilation to be energized. Since the current equipment status indicates that ventilation is energized, entry into the ZOI is permitted as indicated by a “Y” in the Entry code column.

Intelligent Barrier Entry Signal—When all above Entry codes are processed an entry signal will be generated by the intelligent barrier controlling the Zone of Interest. In this case each Entry code is “Y”, indicating a permissible entry by each category. If all Entry codes are “Y” an entry signal will be generated resulting in a green light illuminated on the Intelligent Barrier and a locking mechanism on the barrier opening.

Zone Entry Data File—Upon the entry of a user into a Zone of Interest a Zone Entry Data File will be generated. Such a file may include: date and time of entry, zone entered, area condition monitor readings upon entry, and area equipment status upon entry.

Such a file will be immediately transmitted to the Portable device and preferably to the CSDS.

Zone Exit Data File—Upon the Exit of a user from a Zone of Interest a Zone Exit Data File will be generated. Such a file may include: date and time of exit, zone exited, area condition monitor readings upon exit, and area equipment status upon exit.

Such a file will be transmitted to the Portable device and preferably to the CSDS.

User Logout—Upon logout by the user, all Zone Entry and Zone Exit data files will be transmitted from the portable device to the CSDS. Personnel and administrative records related to zone entry may be updated with the information contained in the Zone Entry and Zone Exit data files.

Those skilled in the art will appreciate that the invention may be practiced in network computing environments with many types of computer system configurations, including, personal computers, laptop computers, hand-held devices, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Many other benefits will no doubt become apparent from future application and development of this technology.

All patents, published applications, and articles noted herein are hereby incorporated by reference in their entirety.

It will be understood that any one or more feature, component, or operation of one embodiment described herein can be combined with one or more other features, components, or operations of another embodiment. Thus, the present invention includes any and all combinations of components, features, and/or operations of the embodiments described herein.

As described hereinabove, the present invention solves many problems associated with previous type devices and systems. However, it will be appreciated that various changes in the details, materials and arrangements of parts, which have been herein described and illustrated in order to explain the nature of the invention, may be made by those skilled in the art without departing from the principle and scope of the invention.

What is claimed is:

1. A system for controlling access by individuals into at least one zone of interest, the system comprising:
a plurality of portable devices each of which is carried by an individual and includes a microprocessor, memory provisions, an on-board power source, and provisions for transmitting information;
at least one intelligent barrier associated with the zone of interest such that the intelligent barrier is selectively operable to allow entry by the individual into the zone of interest or deny entry into the zone of interest, the intelligent barrier including provisions for transmitting information;
a computer system including (i) input provisions for receiving information from at least one of the plurality of portable devices and the at least one intelligent barrier, (ii) processing provisions for executing one or more algorithms using the received information, and (iii) output provisions for providing operating instructions to the at least one intelligent barrier according to the algorithms;
wherein the instructions from the computer system are used to selectively operate the at least one intelligent barrier to thereby allow or deny entry of the individual carrying a portable device into the zone of interest.

2. The system of claim 1 wherein the plurality of portable devices, the at least one intelligent barrier, and the computer system each communicate bi-directionally with one another.

3. The system of claim 1 wherein the portable device is a dosimeter.

4. The system of claim 1 wherein the intelligent barrier is selected from the group consisting of a gate, a turnstile, and a door.

5. The system of claim 1 wherein the intelligent barrier also includes provisions for receiving information from at least one of the portable devices and the computer system.

6. The system of claim 1 wherein the portable device also includes provisions for receiving information from at least one of the intelligent barriers and the computer system.

7. The system of claim 1 wherein the portable device contains information about the individual.

8. The system of claim 1 wherein the portable device contains information about the zone of interest.

9. The system of claim 1 wherein the system controls access into a plurality of zones of interest.

10. The system of claim 1 wherein the intelligent barrier also includes memory provisions for storing information and an electronic processor for processing information utilized in the operation of the intelligent barrier also includes memory provisions for storing information and an electronic processor for processing information utilized in the operation of the intelligent barrier.

11. A method for controlling access into a zone of interest, the method comprising:
providing a system including (i) a portable device, (ii) an intelligent barrier associated with the zone of interest, and (iii) a computer system in communication with the portable device and the intelligent barrier;
assigning the portable device to a user;
transferring information associated with the user including user data to the portable device;
transferring information associated with the zone of interest including entry data to the portable device;
the user presenting the portable device to the intelligent barrier upon attempting to access the zone of interest;
transferring the user data from the portable device to the computer system;
transferring the entry data from the portable device to the computer system;
the computer system assessing whether the user data and the entry data is acceptable for access by the user, and if so, then issuing a signal to the intelligent barrier indicative of allowing access into the zone of interest;
the intelligent barrier receiving the signal and then enabling access by a user into the zone of interest.

12. The method of claim 11 wherein the computer system also assesses whether zone area conditions are satisfactory.

13. The method of claim 11 further comprising:
transferring information including entry statistics from the intelligent barrier to the computer system.

14. The method of claim 11 further comprising:
transferring information from the computer system to the portable device.
